(19) United States
(12) Patent Application Publication
(10) Pub. No.: US 2008/0068645 A1
(43) Pub. Date: Mar. 20, 2008

(54) DEVICE MANAGEMENT METHOD AND DEVICE MANAGEMENT SYSTEM

(76) Inventor: Toshio NAKANO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/851,585

(22) Filed: Sep. 7, 2007

(30) Foreign Application Priority Data
Sep. 19, 2006 (JP) 2006-253216

(51) Int. Cl. G06F 3/12

(52) U.S. Cl. 358/1.15

(57) ABSTRACT

In a device management system, a printer is connected to a host computer via a network, and the host computer manages a status of the printer. When the host computer acquires information from the printer, the host computer acquires information whether the printer is in an energy-saving mode in advance. The host computer changes information items to be acquired in the energy-saving mode and in other mode, thereby preventing the cancellation of the energy-saving mode.

### CROSS-REFERENCE TO RELATED APPLICATIONS

The present application claims priority to and incorporates by reference the entire contents of Japanese priority document, 2006-253216 filed in Japan on Sep. 19, 2006.

### BACKGROUND OF THE INVENTION

1. Field of the Invention

The present invention relates to a device management method of managing an image input/output device such as a photocopier, a printer, and a scanner, using a host computer, and to a device management system performing the device management method.

2. Description of the Related Art

In a field of device management, a technique described in Japanese Patent Application Laid-open No. 2005-94681 is known, for example. According to the technique, when a network system includes a plurality of network devices, such as a photocopier, a printer, a multi-function peripheral, and a personal computer, which are connected to each other via a network, if one network device goes into an energy-saving mode, the pertinent network device sends a sleep frame to other network devices by broadcast via the network to notify that the pertinent network device enters the energy-saving mode in order to enhance an energy-saving effect in the whole system.

In the network system that includes input-output devices connected as described above, a photocopier or a printer temporarily consumes a great deal of electric power on, for example, making a copy or a print. When not performing copying or printing, the photocopier or the printer enters a low-power consumption mode (i.e., “energy-saving mode”), which is also called sleep mode, and remains in the energy-saving mode until next processing is requested in order to save the power consumption.

In the device management, sometimes the status of each device is grasped through status polling. The status polling is processing of acquiring information about the device at predetermined intervals. In the status polling, same type of information is acquired regularly regardless of the status of each device.

In some cases, a command is transmitted to a device, which makes the device in the energy-saving mode return to a normal mode. Hence, the device returns to the normal mode from the energy-saving mode during the status polling every time the device receives such a command. In addition, in the energy-saving mode, some pieces of information do not need to be renewed. The acquisition of the same type of information in the energy-saving mode as well as in other mode results in unnecessary transmission of commands, whereby network traffic is increased, and an extra load is placed on the network.

### SUMMARY OF THE INVENTION

It is an object of the present invention to at least partially solve the problems in the conventional technology.

According to one aspect of the present invention, a device management method includes acquiring information indicating a status of an input/output device connected to a host computer via a network in advance, when the host computer acquires information from the input/output device, changing an information item to be inquired of the input/output device in accordance with the information indicating the status of the input/output device, and managing the input/output device based on the information item changed.

Further, according to another aspect of the present invention, a device management system includes an input/output device, and a host computer that is connected to the input/output device via a network to manage a status of the input/output device. The host computer includes an acquiring unit that acquires information indicating the status of the input/output device in advance, when the host computer acquires information from the input/output device, and a changing unit that changes an information item to be inquired of the input/output device in accordance with the information indicating the status of the input/output device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a printer as an input/output device according to an embodiment of the present invention;

FIG. 2 is a block diagram of a host computer according to the embodiment;

FIG. 3 is a flowchart of a process procedure of inquiring whether the printer shown in FIG. 1 is in an energy-saving mode;

FIG. 4 is a flowchart of a process procedure of inquiring whether the printer shown in FIG. 1 is in a specific mode other than the energy-saving mode;

FIG. 5 is a flowchart of a process procedure of changing an information item to be inquired depending on optional function information about the printer shown in FIG. 1;

FIG. 6 is a flowchart of a process procedure combining the processes shown in FIGS. 3 to 5; and

FIG. 7 is a flowchart of a process procedure of setting a process of changing an information item to be acquired with the host computer shown in FIG. 2.

### DETAILED DESCRIPTION OF THE PREFERRED EMBODIMENTS

Exemplary embodiments of the present invention will be explained below in detail with reference to the accompanying drawings.

In a system according to an embodiment of the present invention, a printer is connected to a host computer.

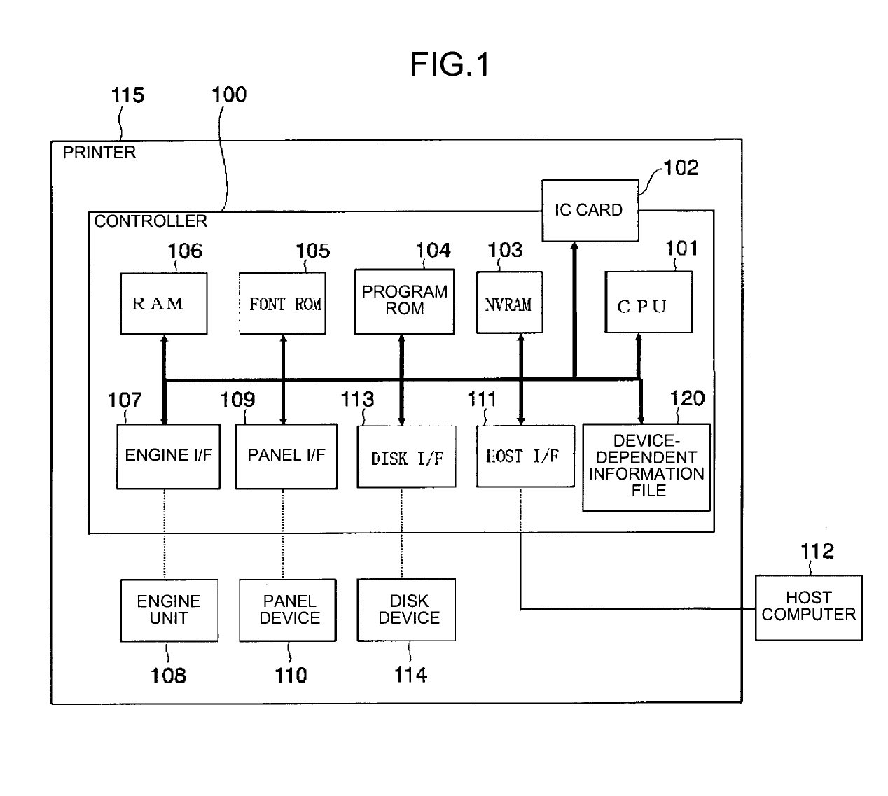

In FIG. 1, a printer 115 includes a controller 100, an engine unit 108, a panel device 110, and a disk device (DISK) 114, and the controller 100 is connected to a host computer 112. The host computer 112, which is a higher level device above the printer 115, transmits a printer setting command and printing data to the printer 115. The engine unit 108 is an engine that carries out actual printing. The panel device 110 notifies a user of a current status of the printer, and gives a mode instruction. The disk device 114 includes a hard disk device and stores therein various data, such as font data, a computer program, and printing data.

The controller 100 includes, a central processing unit (CPU) 101, an integrated circuit (IC) card 102, a non-volatile random access memory (NVRAM) 103, a program read-only memory (ROM) 104, a font ROM 105, a random access memory (RAM) 106, an engine interface 107, a panel interface 109, a disk interface 113, a host interface 111, and a device-dependent information file 120.

The CPU 101 is a central control device that controls the whole controller in accordance with a computer program in the program ROM 104, a mode instruction from the panel device 110, and a command from the host computer 112. The IC card 102 externally supplies font data and a computer program. The NVRAM 103 is a non-volatile storage device that stores therein information, such as details of a mode instruction from the panel device 110. The program ROM 104 stores therein a control program for the controller, and the font ROM 105 stores therein pattern data of a font. The RAM 106 is a storage device to be used as a work memory of the CPU 101, an input buffer for input data, a page buffer for printing data, a memory for a downloaded font, and the like.

The engine interface 107 communicates a command, a status, and printing data to the engine unit 108. The panel interface 109 communicates a command and a status to the panel device 110. The host interface 111 communicates with the host computer 112. The host interface 111 is usually a Centronics interface or Recommended Standard 232C (RS-232C). The disk interface 113 communicates with the disk device 114.

The device-dependent information file 120 stores therein specific information about a device, which is dependent on the device. Information included in the device-dependent information file 120 is information about configurations of devices possible to be acquired by the host computer 112, for example, tray configuration information, availability of a facsimile if a facsimile function is optional, and toner configuration information.

When the controller 100 receives data (a character code, a control code, and a control command) from the host computer 112 via the host interface 111, the controller 100 temporarily stores the received data in the input buffer. The controller 100 then takes out data stored in the input buffer, and stores in the page buffer page layout information, such as a header address of a font pattern for each character of data, the width of the font pattern, the height of the font pattern, and a print position. When the page buffer is completed for one page, subsequently, data in the page buffer is expanded into a bitmap format in a frame buffer. When the expansion is finished, the controller 100 sends a paper-feeding tray selecting command, a paper-output tray selecting command, and a printing command to the engine unit 108 via the engine interface 107, and outputs the bitmap data expanded in the frame buffer as video data.

On the other hand, the engine unit 108 executes a paper feed from the selected paper-feeding tray, prints out based on the video data, and outputs to the selected paper-output tray, in accordance with the paper-feeding tray selecting command, the paper-output tray selecting command, and the printing command sent from the controller 100.

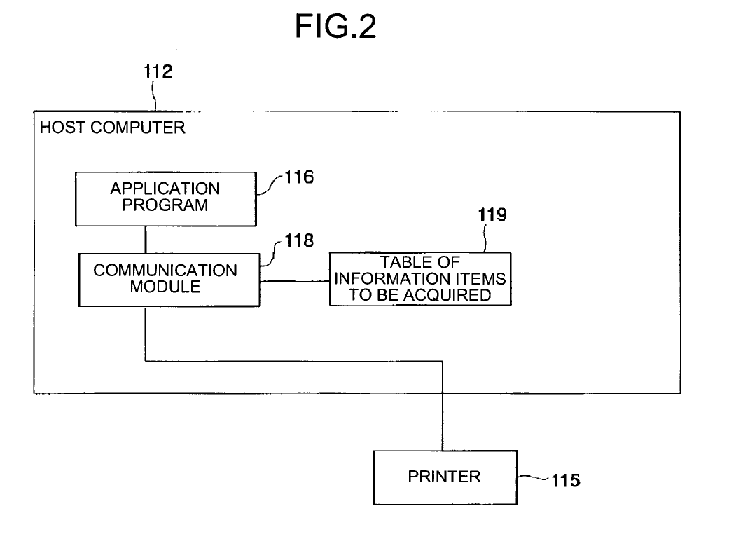

In FIG. 2, the host computer 112 includes an application program 116, a communication module 118, and a table of information items to be acquired 119. When acquiring device information from the printer 115, the application program 116 requests the communication module 118 to acquire the device information. The communication module 118 inquires of the printer 115, which the communication module 118 manages, for the information. The communication module 118 sends the information returned as a result of the inquiry to the application program 116, whereby the application program 116 can achieve an object, i.e., can acquire the information from the printer 115. On the table of information items to be acquired 119, lists of various information items to be acquired as required for printing are described.

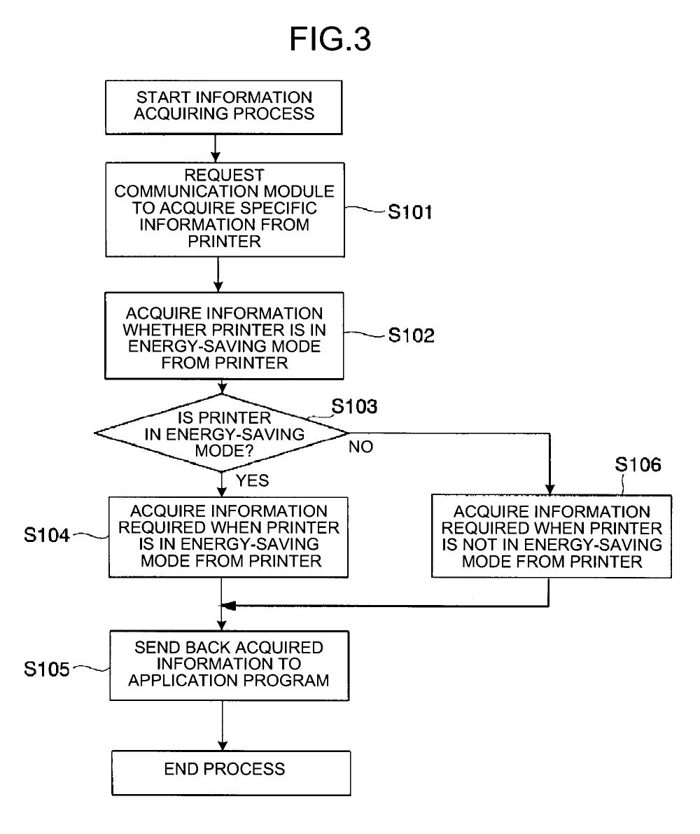

FIG. 3 is a flowchart of a process procedure of inquiring whether the printer is in an energy-saving mode. When the application program 116 in the host computer 112 acquires device information from the printer 115, the application program 116 first requests the communication module 118 to acquire information from the printer 115 (step S101). In response to the request, the communication module 118 inquires of the printer 115 whether the printer 115 is in the energy-saving mode, and acquires information (step S102). Based on the acquired information, the communication module 118 determines whether the printer 115 is in the energy-saving mode (step S103).

If the printer 115 is in the energy-saving mode, the communication module 118 takes out from the table of information items to be acquired 119 a list of information items to be acquired that are required when the printer 115 is in the energy-saving mode, and acquires required information from the printer 115 in accordance with the list (step S104). The table of information items to be acquired 119 stores therein lists of items required to be acquired in respective modes. The communication module 118 then sends back the acquired information to the application program 116 (step S105), and the process is terminated.

On the other hand, if it is confirmed at step S103 that the printer 115 is not in the energy-saving mode, the communication module 118 takes out a list of information items to be acquired that are required when the printer 115 is not in the energy-saving mode, acquires information in accordance with the list from the printer 115 (step S106), and goes to step S105.

Information items to be acquired include a command to cancel the energy-saving mode of the printer 115. The table of information items to be acquired 119 is so designed that the use of such command during the energy-saving mode is prevented, and accordingly, an improper cancellation of the energy-saving mode can be avoided.

Information unnecessary to be inquired during the energy-saving mode is, for example, the amount of paper remaining in a paper feeding tray. Since the printer 115 does not perform a printing operation in the energy-saving mode, a state of the amount of paper remaining in the paper feeding tray is expected to remain unchanged. Therefore, update of information about the amount of remaining paper is hardly required. However, if a user replenishes paper into the paper feeding tray, there is a change in the amount of remaining paper in the paper feeding tray. If such condition is restricted, the system can work sufficiently in practical use. In addition, when the processing is performed to prevent the acquisition of unnecessary information, network traffic can be reduced.

Thus, when information of the printer is to be acquired, the status of the printer is inquired in advance, and the information items to be inquired of the printer are changed accordingly, whereby increase in network traffic can be prevented and performance is enhanced. Moreover, since the information for canceling the energy-saving mode is not transmitted during the energy-saving mode, the printer is prevented from mistakenly cancelling the energy-saving mode, and does not consume extra energy.

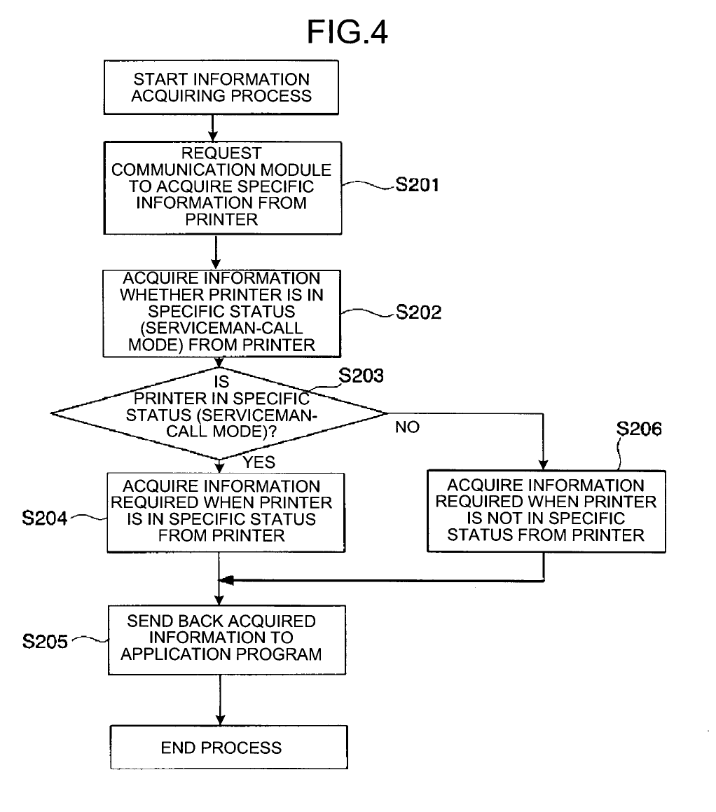

FIG. 4 is a flowchart of a process procedure of inquiring whether the printer is in a specific mode other than the energy-saving mode. In the process, similarly to the process shown in FIG. 3, when the application program 116 acquires device information from the printer 115, the application program 116 first requests the communication module 118 to acquire information from the printer 115 (step S201). In response to the request, the communication module 118 inquires of the printer 115 for information on whether the printer 115 is in a specific mode, such as a serviceman-call mode, and acquires information (step S202). Based on the acquired information, the communication module 118 determines whether the printer 115 is in the specific mode (step S203).

If the printer 115 is in the specific mode, the communication module 118 takes out from the table of information items to be acquired 119 a list of information items to be acquired that are required when the printer 115 is in the specific mode, and acquires required information from the printer 115 in accordance with the list (step S204). The communication module 118 then sends back the acquired information to the application program 116 (step S205), and the process is terminated.

On the other hand, if it is confirmed at step S203 that the printer 115 is not in the specific mode, the communication module 118 takes out a list of required information items to be acquired from the table of information items to be acquired 119, and thereby acquires required information from the printer 115 in accordance with the list (step S206). The process then goes to step S205, and is terminated.

Though the above process is not related with the energy saving, the process is still advantageous in that the network traffic can be reduced.

Thus, by considering a specific mode, such as a serviceman-call mode, in addition to the energy-saving mode of the printer 115, and changing information items to be inquired of the printer 115 in accordance therewith, the increase in network traffic can be prevented, and the performance can be improved.

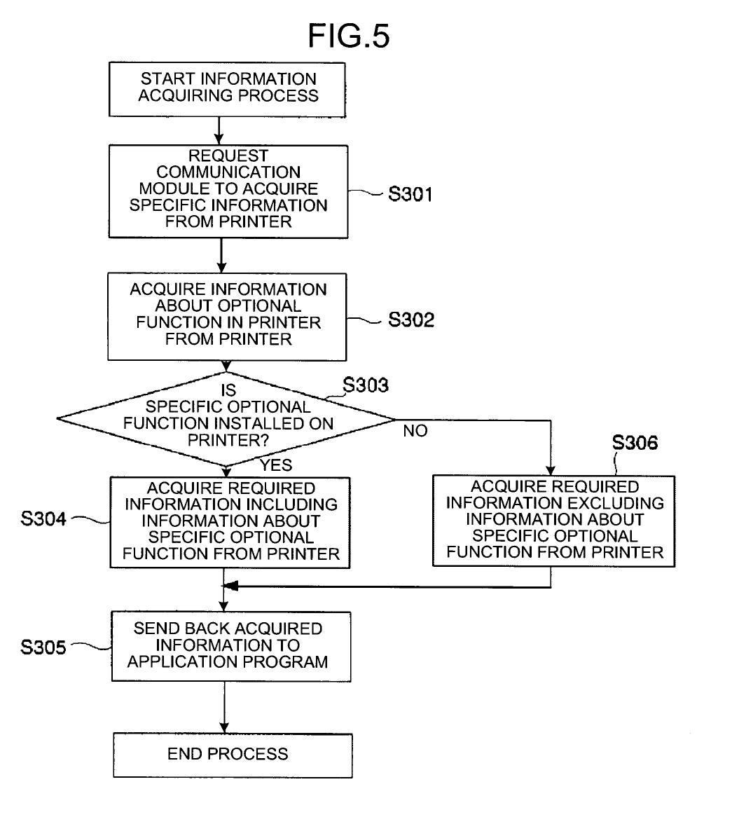

FIG. 5 is a flowchart of a process procedure of changing an information item to be inquired depending on optional function information about the printer. In the process, similarly to the process shown in FIG. 3, when the application program 116 acquires device information from the printer 115, the application program 116 first requests the communication module 118 to acquire information from the printer 115 (step S301). In response to the request, the communication module 118 inquires of the printer 115 for a status of an optional function installed on the printer 115 (for example, whether the printer 115 has a facsimile function), and acquires information about the status (step S302).

The communication module 118 determines whether the printer 115 has the specific optional function (step S303). If the printer 115 has the specific optional function, the communication module 118 acquires required information including information about the optional function from the printer 115 (step S304). In accordance with an installation status of the optional function in the printer 115, the communication module 118 takes out from the table of information items to be acquired 119 a list of required information items to be acquired, and acquires required information from the printer 115 in accordance with the list. In this case, on the table of information items to be acquired 119, a list of information items that are required to be acquired is described in accordance with each status of optional functions. Specifically, if a facsimile function is not installed on the device, facsimile counter information does not need to be acquired. Therefore, an item of the facsimile counter information is excluded from the list of items to be acquired for the device. The communication module 118 then sends back the acquired information to the application program 116 (step S305), and the process is terminated.

If it is determined at step S303 that the printer 115 does not have the specific optional function, the communication module 118 acquires required information excluding information about the optional function from the printer 115 (step S306), and then goes to step S305.

Thus, information about the configuration of the printer 115 can be obtained first, and then information items to be inquired can be changed based on the configuration information, accordingly, the increase in network traffic can be prevented, and the performance can be improved.

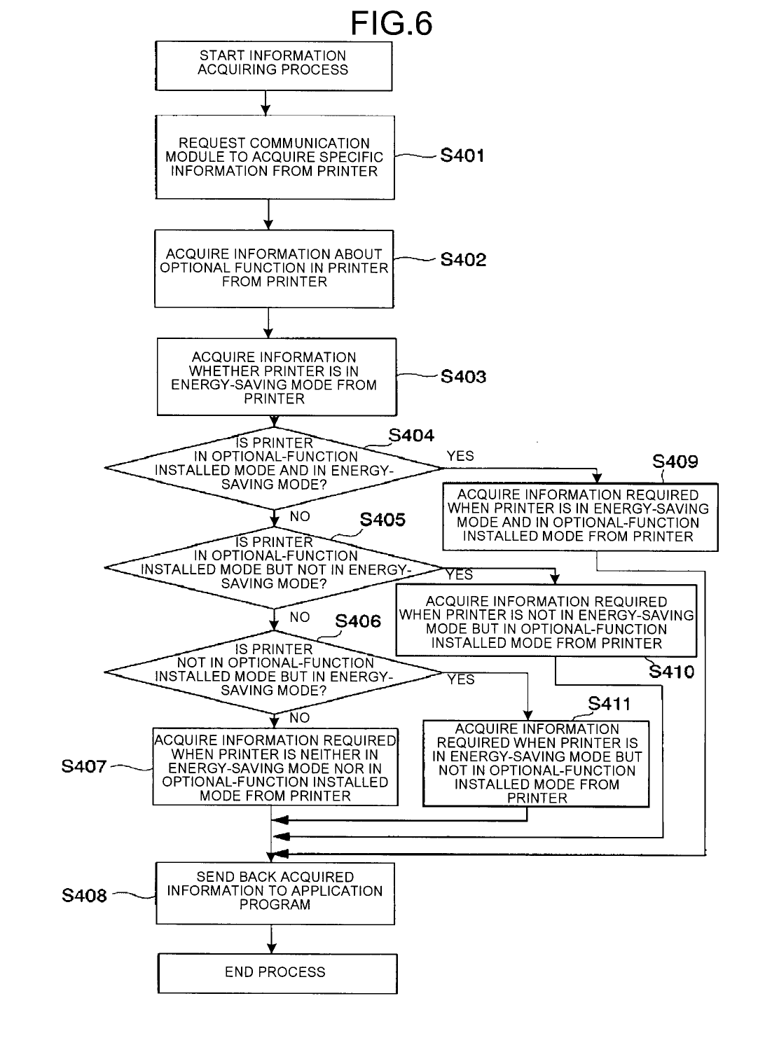

FIG. 6 is a flowchart of a process procedure combining the processes shown in FIGS. 3 to 5. An example shown in FIG. 6 combines processing in the energy-saving mode and processing in the optional-function installed mode.

In the process, similarly to the process shown in FIG. 3, when the application program 116 acquires device information from the printer 115, the application program 116 first requests the communication module 118 to acquire information from the printer 115 (step S401). In response to the request, the communication module 118 inquires of the printer 115 for a status of an optional function installed on the printer 115, and acquires information about the status (step S402). Furthermore, the communication module 118 inquires of the printer 115 for information on whether the printer 115 is in the energy-saving mode, and acquires information (step S403). Based on the acquired information, the communication module 118 determines whether the printer 115 is in the optional-function installed mode and the energy-saving mode (step S404).

If the printer 115 is not in the optional-function installed mode or the energy-saving mode, the communication module 118 determines whether the printer 115 is in the optional-function installed mode but not in the energy-saving mode (step S405). If the two conditions are not satisfied, the communication module 118 determines whether the printer 115 is not in the optional-function installed mode but in the energy-saving mode (step S406). If the two conditions are not satisfied, the communication module 118 acquires information that is required when the printer is neither in the energy-saving mode nor in the optional-function installed mode from the printer 115 (step S407). The communication module 118 sends back the acquired information to the application program 116 (step S408), and the process is terminated.

On the other hand, if it is determined at step S404 that the printer 115 is in the optional-function installed mode and the energy-saving mode, the communication module 118 acquires information that is required when the printer 115 is in the energy-saving mode and the optional-function installed mode from the printer 115 (step S409), and then goes to step S408.

If it is determined at step S405 that the printer 115 is in the optional-function installed mode but not in the energy-saving mode, the communication module 118 acquires information that is required when the printer 115 is not in the energy-saving mode but in the optional-function installed mode from the printer 115 (step S410), and then goes to step S408.

Furthermore, If it is determined at step S406 that the printer 115 is not in the optional-function installed mode but in the energy-saving mode, the communication module 118 acquires information that is required when the printer 115 is in the energy-saving mode but not in the optional-function installed mode from the printer 115 (step S411), and then goes to step S408.

By changing information items to be acquired for printer management depending on the conditions, the information acquiring process can be completed based on information of less amount.

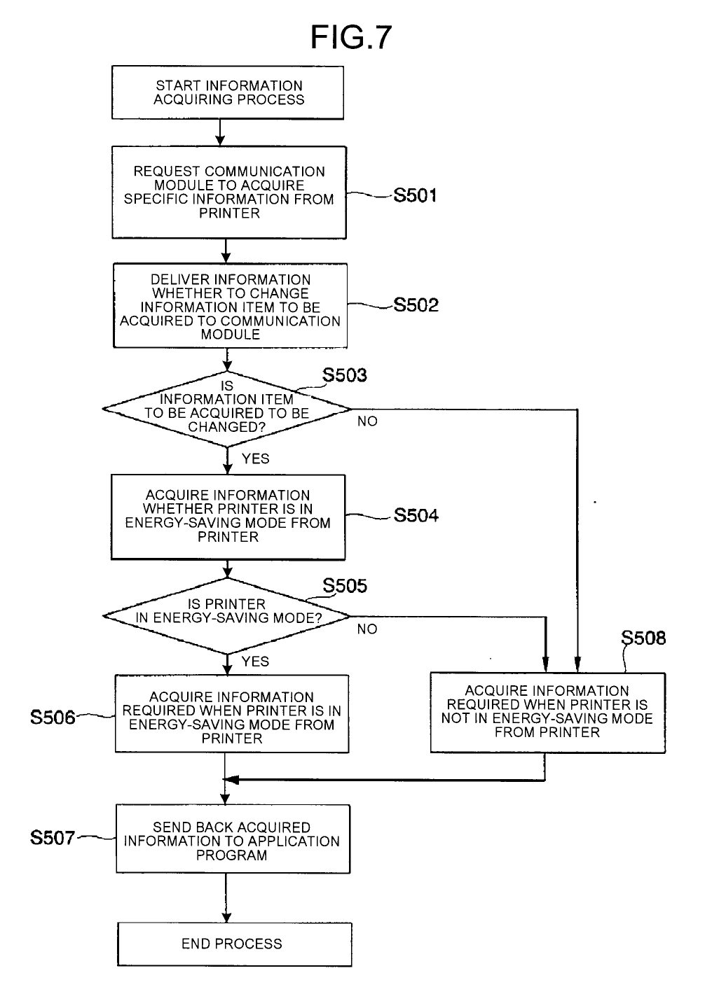

FIG. 7 is a flowchart of a process procedure of setting a process of changing an information item to be acquired using the host computer. In the process, similarly to the process shown in FIG. 3, when the application program 116 acquires device information from the printer 115, the application program 116 first requests the communication module 118 to acquire information from the printer 115 (step S501). When requesting, the application program 116 delivers to the communication module 118 information indicating whether an information acquiring process set in the application program 116 is to be changed in accordance with a device status or not (step S502). A user can set the information indicating whether the information acquiring process is to be changed in accordance with the device status or not via a user interface (UI) screen created by the application program 116.

The communication module 118 then determines whether to change an information item to be acquired (step S503). If an information item to be acquired is to be changed, the communication module 118 acquires information whether the printer 115 is in the energy-saving mode or not from the printer 115 (step S504). The communication module 118 then determines whether the printer 115 is in the energy-saving mode (step S505). If the printer 115 is in the energy-saving mode, the communication module 118 acquires information required in the energy-saving mode from the printer 115 (step S506). The communication module 118 then sends back the acquired information to the application program 116 (step S507), and the process is terminated.

If it is determined at step S503 that any information item to be acquired is not to be changed, and if it is determined at step S505 that the printer 115 is not in the energy-saving mode, the communication module 118 acquires information that is required when the printer 115 is not in the energy-saving mode from the printer 115 (step S508), and goes to step S507.

Thus, since a user sets whether or not to use the processing, flexibility in operation of the printer management is increased. Specifically, when the user wants to realize accurate information updating by constantly acquiring predetermined information items even during the energy-saving mode, the user can make a setting so as not to use the function.

According to the embodiment, a printer is explained as an example of the image input-output device. However, the embodiment can also be applied to a photocopier, a facsimile, a scanner, or a multi-function peripheral, or the like.

According to the embodiments of the present invention, a device from which information is to be acquired is inquired in advance whether the device is in the energy-saving mode, and information items to be inquired of the device are changed in accordance with the status of the device. Accordingly, increase in network traffic can be prevented, and improvement in performance can be achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device management method comprising:
acquiring information indicating a status of an input/output device connected to a host computer via a network in advance, when the host computer acquires information from the input/output device;
changing an information item to be inquired of the input/output device in accordance with the information indicating the status of the input/output device; and
managing the input/output device based on the information item changed.

2. The device management method according to claim 1, wherein
the information indicating the status of the input/output device is information which indicates whether the input/output device is in an energy-saving mode, and
cancellation of the energy-saving mode during energy-saving time is prevented based on the information item changed.

3. The device management method according to claim 1, wherein when the host computer acquires information from the input/output device, if the input/output device is in a predetermined status, the host computer acquires no more information.

4. The device management method according to claim 1, wherein the information indicating the status of the input/output device is information about a configuration of the input/output device.

5. The device management method according to claim 1, wherein when the host computer acquires information from the input/output device, the host computer changes an information item to be acquired for device management.

6. The device management method according to claim 4, wherein whether to change the information item to be acquired is set on a user interface of the host computer.

7. A device management system comprising:
an input/output device; and
a host computer that is connected to the input/output device via a network to manage a status of the input/output device, the host computer including
an acquiring unit that acquires information indicating the status of the input/output device in advance, when the host computer acquires information from the input/output device, and
a changing unit that changes an information item to be inquired of the input/output device in accordance with the information indicating the status of the input/output device.

8. The device management system according to claim 7, wherein
the information indicating the status of the input/output device is information which indicates whether the input/output device is in an energy-saving mode, and
cancellation of the energy-saving mode during energy-saving time is prevented based on the information item changed.

9. The device management system according to claim 8, wherein when the host computer acquires information from the input/output device, if the input/output device is in a predetermined status, the host computer acquires no more information.

10. The device management system according to claim 7, wherein the information indicating a status of the input/output device is information about a configuration of the input/output device.

11. The device management system according to claim 7, wherein when the host computer acquires information from the input/output device, the host computer changes an information item to be acquired for device management.

12. The device management system according to claim 11, wherein whether to change the information item to be acquired is set on a user interface of the host computer.
